(19) United States
(12) Patent Application Publication
(10) Pub. No.: US 2011/0264607 A1
(43) Pub. Date: Oct. 27, 2011

(54) Display For Food Bags

(75) Inventors: Russell E. Bell, Pleasanton, CA (US); Lisa Phillips, Pleasanton, CA (US); Mary Jo Cook, Pleasanton, CA (US); Marcus Wang, Pleasanton, CA (US)

(73) Assignee: The Glad Products Company, Oakland, CA (US)

(21) Appl. No.: 13/178,817

(22) Filed: Jul. 8, 2011

Related U.S. Application Data
(63) Continuation-in-part of application No. 12/509,846, filed on Jul. 27, 2009.

(51) Int. Cl. G06Q 90/00

(52) U.S. Cl. 705/500

(57) ABSTRACT

A method for selling individual storage bags used for the storage of fresh foods comprising the steps of providing individual storage bags on a display in store and adjacent a fresh food product to be purchased, permitting the shopper to place the fresh food product in the individual storage bag before checkout, and charging the shopper for the bag on a per bag basis separately from the food purchased.

### CROSS-REFERENCE TO RELATED APPLICATIONS

This application is a continuation in part of U.S. patent application Ser. No. 12/509,846, filed Jul. 27, 2009.

### BACKGROUND OF THE INVENTION

1. Field of the Invention

The present invention relates to an in-store method for providing individual containers to a consumer, where the containers are characterized by having at least one product storage enhancing characteristic and permitting the consumer to choose the empty, individual container sold by unit, fill the container with individual bulk produce or other items sold by weight, and pay for the combined container and bulk items at the check-out counter both by container unit and bulk item weight.

2. Description of the Related Art

There are many known materials and methods related to the purchase and storage of bulk fresh food items, such as fruits, cheese, fish, vegetables, coffee beans and the like in a grocery store or “farmer's market” setting. Most commonly, a shopper is given a container, such as a plastic or paper bag or wrap, into which the shopper or shop keeper places the desired amount of bulk product for purchase. Most often, the container and product are then carried to the point of purchase where the combined bag and product are weighed and the consumer is charged for the combination based on the per weight cost of the product. In some settings, the store will permit, or require, that the store staff or shopper weigh and label the food items in the department in which they are displayed in order to speed the purchase of the item at the checkout counter and to avoid the consumer having to pay for the weight of the container with his or her purchase. This process can include the placement by the store staff of a universal product code or so-called “bar” code on the outside of the container so that the container and product can be scanned together at a checkout counter.

In order to minimize the cost to the store owner of providing these plastic or paper containers to the consumer in the store, the materials that are provided, for example plastic bags, are made of very inexpensive material; a material that has little value in terms of protecting and storing the product. These materials provide the benefit of permitting the shopper to carry the food item (say, for example, a few apples) to the front counter for purchase. The material from which the bag is made is also extremely light, making the cost of the bag as charged to the consumer by weight, de minimis. On the other hand, the plastic bag provides no protection or storage benefit when taken home. That is, the item that has been carried from the store in the plastic bag must typically be removed from the plastic bag (or other freely supplied container) in order to avoid faster spoilage caused by the characteristics of the bag. Further, the use of these bags or other containers is wasteful, since they are most often not sturdy enough to be reused.

Published US patent application 2006/0171606 A1 describes a bag having characteristics that provide the benefit of permitting quick inspection of the contents, for example at airport security or other security checkpoints where such bags and their contents need to be inspected. This application also describes a business method in which such bags are made available for sale to a consumer/user near their point of use, generating revenue for the seller.

Many fresh food items, such as produce, fruit, vegetables, cheese and meat, are sold both in prepackaged amounts and in bulk. The availability of these fresh food items in bulk allows the consumer to choose both the right amount and the desired quality of these fresh food items. This may not be possible with prepackaged fresh food items. However, the consumer currently lacks the ability to get this choice and also optimally package this choice directly and easily in the supermarket.

There are many disclosures of plastic bags and other containers that are suitable for the packaging and storage of fresh food items, such as fresh fruits and vegetables, and that are made of materials (or are configured in a particular way) so as to permit the food item to remain unspoiled for an extended period of time. That is, these containers are designed to prolong the time before the product becomes spoiled relative to storage without a container (e.g. simply placed in a refrigerator) or in the thin film plastic bags given away in the grocery store. Such containers are sometimes available to customers of the same store in which fresh food products are sold, however, they are not sold individually and are not typically positioned in the same area of the store as the fresh food. There is also no mechanism for the customer to combine the container with their desired amount of bulk product items prior to check-out. The consumer must either try to find a suitable pre-packaged amount of product items or must buy separately a plurality of specialized containers and bulk product items in ordinary containers, and then remember to repackage the bulk product items in the specialized containers at home, potentially resulting in increased spoilage. Thus, for example, customers who are purchasing fruits or vegetables will typically use the free plastic bags in the produce section, take them home, remove the produce from the free bag and place it in a separate storage container that will permit the produce to remain fresh for a longer period of time. Or, the customer will take the produce home in the provided plastic bag and store it in that bag, resulting in relatively fast spoilage of the produce.

### SUMMARY OF THE INVENTION

The present invention comprises a method for individually selling a container, such as a recloseable and/or resealable plastic bag or other container, the container having at least one characteristic for improving the storage time or quality of a fresh food item stored in the container. In one form, the method is accomplished by making a storage container according to the invention individually available in the section of a store selling the bulk food item, permitting the customer access to the individual container (and permitting the customer to place the food item in the container), and charging the customer separately from the amount of bulk food item by weight for the container on a per container basis (i.e. typically not by weight), for example when the customer reaches the checkout stand of the store. The method provides the customer with a number of advantages: being able to directly place the desired food item in the container at the store, being able to purchase the container separately and not in packages of multiple containers having disposable secondary packaging, and to avoid having to replace the food item in a different storage container when the purchase is brought home. These advantages, coupled with the in-store use of a container that keeps the food fresher longer, provides significant added value to the purchaser/consumer. Overall, for the purchaser, this also results in less handling of the food item, avoiding possible contamination and/or bruising, and an increased chance that the food item will be stored properly when taken home. For the seller, a new revenue stream is created as consumers will better appreciate the value of using a container according to the invention which is made individually available to them close to the time and place in the store where the consumer decides to purchase the fresh food. The consumers may also be persuaded to purchase easily spoiled items, since the consumer is immediately presented with an option to decrease the spoilage of those items.

### DETAILED DESCRIPTION

The invention is a method for selling an individual storage container, the method comprising the steps of providing to a store customer a fresh food item sold in bulk, the fresh food item selected from the group consisting of fruit, vegetables, and combinations thereof; providing to a store customer an empty, individual storage container from a packet of empty, individual storage containers to a store customer, the packet not being suitable for sale and the individual storage container being suitable for sale, the individual storage container including a characteristic that permits food stored in the container to remain fresh longer than if the food item is not stored in the container, the individual storage container having both a description of a suitable fresh food item and a universal product code marking; permitting the customer to place the desired amount of bulk food item inside the empty, individual storage container to obtain a desired amount of bulk food item packaged for freshness; and permitting the customer to purchase in one transaction the combination of the desired amount of bulk food item and the individual storage container, the individual container purchased on a per unit basis and the bulk food item purchase on a per weight basis, the transaction not requiring the removal of the bulk food item from the individual storage container.

In another embodiment, the invention is a method for selling an individual storage container, the method comprising the steps of providing to a store customer a fresh food item sold in bulk, the fresh food item selected from the group consisting of fruit, vegetables, and combinations thereof, the fresh food item having a first universal product code marking; providing to a store customer an empty, individual storage container from a packet of empty, individual storage containers to a store customer, the packet not being suitable for sale and the individual storage container being suitable for sale, the individual storage container including a characteristic that permits food stored in the container to remain fresh longer than if the food item is not stored in the container, the individual storage container having both a description of suitable fresh food items and a second universal product code marking; permitting the customer to place the desired amount of bulk food item inside the empty, individual storage container to obtain a desired amount of bulk food item packaged for freshness; and permitting the customer to purchase in one transaction the combination of the desired amount of bulk food item and the individual storage container, the individual container purchased on a per unit basis and the bulk food item purchase on a per weight basis, the transaction allowing reading of both the first universal product code marking and the second universal product code marking, the transaction not requiring the removal of the bulk food item from the individual storage container.

In one form of the invention the method comprises providing a shopper in a grocery and/or produce store access to individual storage containers or bags. The containers can be made available in any of many known ways, for example if the containers are flexible bags, then from a roll of such bags positioned adjacent a display of produce. Storage bags and containers according to the method of the invention are known in the art but have not heretofore been made available for individual use and separate purchase in the store. For example, the bags can be sealable and/or resealable plastic bags such as are sold under brands such as GLAD® or others. According to the invention, however, these bags will be provided for separate and individual purchase rather than in a box or other package of, say, ten, twenty or fifty or more bags. The individual bags are suitable for individual sale, for example by providing a universal product code marking on the individual bag. Since the bags are sold individually and suitable for individual sale, it would not be required that the packet, package, or carton of multiple bags have a universal product code marking, entered into the store sales system, or otherwise be suitable for individual sale. Most advantageously, the bags (or other containers) used in the method of the invention will include at least one feature or characteristic that adds value for the consumer over and above the bags currently provided for free by grocery stores in the produce section. A feature of such bags will be one that provides an extended time of freshness during storage over and above the time that is provided by the plastic bags of the prior art that are commonly provided by the store and not separately charged for. The bags will also be configured such that they are suitable for individual sale, for example, by having a universal product code marking. The bags may also have an indication of their cost on each individual bag and a picture or description of suitable fresh food items, for example, beans.

Typical food bags available to consumers at the point of selection of fresh produce are of ordinary polyethylene film and provide no additional benefit for keeping food fresh. In fact, typical food bags may actually speed the spoilage of fresh produce compared to leaving the produce out in the air, because these bags can trap moisture and prevent fresh oxygen from entering the produce environment. Bags that provide extended freshness can include structural features that provide this benefit (e.g. engineered perforations or breathable films), and/or they may include chemical components that enhance or extend storage time. By “extended freshness” we mean the period of time over which the food item remains fresh in the sense of appearance, taste and/or smell. Where a chemical component is used to provide a benefit, the component may be integrated into the material from which the bag is formed, or it may be included in a component that is added to or inserted in the bag. Such component can be, for example, an insert in the bag which, in addition to including such chemical component, may also absorb moisture and/or provide a cushioning or protective benefit for the produce or other food product stored in the bag.

The characteristic that can be incorporated into the bag or other container used in the method of the invention can relate to the solution of any problem presented when fresh food is placed in the container. For example, the characteristic could be odor reduction for foods that may produce odors (e.g. onions, broccoli, cheese or meat from a deli counter). Other characteristics that could be incorporated into the containers used in the invention could include desiccants, liquid absorbents, ethylene scavengers and oxygen scavengers. One known example of the type of engineered material that can be incorporated into containers according to the invention is disclosed in U.S. Pat. No. 5,891,376 (which is incorporated herein by reference in its entirety), which describes controlled gas permeability film materials that have the advantage of permitting longer term storage of vegetables and other foods.

It is also known in the prior art that carbon dioxide and oxygen atmospheres surrounding produce can be modified by utilizing the innate respiration behavior of the produce where oxygen is converted to carbon dioxide. With modified atmosphere (MA) packaging, produce is stored in polymeric film where the film permeability is exactly matched to the expected respiration behavior as influenced by temperature and atmosphere changes to provide the optimum carbon dioxide and oxygen atmosphere. The accumulated carbon dioxide and oxygen concentration in such a package will be related to the rate at which carbon dioxide and oxygen is consumed or generated by the produce and the container permeability by a simple mass balance. Controlled atmosphere research into broccoli, for example, has shown that oxygen levels below approximately 1% and carbon dioxide levels higher than approximately 15% independently induce offensive off-odors and off-flavors. Reported optimum oxygen and carbon dioxide concentrations for broccoli range from approximately 1 to 2.5% and approximately 5 to 10% respectively. Controlled atmosphere packaging achieves extended produce life because of effects such as slowing respiration and inhibiting pathogen growth.

The bag film material may be a controlled permeability film of any suitable type. The porosity of the film may be controlled by incorporation of an inert filler. The film forming polymer may be selected from polyolefins including polyethylene and polypropylene, polyesters including polyethylene terephthalate and polybutylene terephthalate, vinyl polymers including polyvinyl chloride, polyvinyl acetate, ethylene-vinyl acetate copolymers and ethylene-vinyl alcohol copolymers, polycarbonates and polystyrenes polyalkylene oxide polymers, including polyethylene oxide polymer; and blends of any of the above. Preferably the film forming polymer is a polyolefin more preferably polyethylene. A low density polyethylene is particularly preferred.

The inert filler may be of any suitable type. The inert filler may be an organic or inorganic filler. The inert filler may be a naturally-occurring porous material or synthetic porous material. The naturally occurring porous materials may be selected from inorganic materials, such as, pumice, tuff, rhyolite, dacite, reticulite, scoria, lapilli, agglomerate, perlite, pumicite, other volcanic rocks, natural zeolites or sandstones and organic materials, such as coal, char, charcoal, starch, seaweed, polymeric carbohydrates. The synthetic materials may be selected from porous glasses such as “Vycor”, clays modified to produce porosity, silicate phases, such as, cordierite or mullite or metal oxides, such as alumina, silica, zirconia or magnesia, or cerium compounds, or hydrophilic organic polymers, such as polyvinyl alcohol or polyacrylamide. Synthetic metallic compounds such as alumina, aluminum isopropoxide may be used.

Pumice particles having a particle size greater than the intrinsic film thickness of the film forming polymer has been found to be particularly suitable. The film forming polymer may be present in amounts of from approximately 50 to 99.995%, preferably 85 to 99.95% by weight based on the total weight of the controlled permeability film. More preferably the film forming polymer is present in amounts of approximately 90 to 99.5% by weight based on the total weight of the controlled permeability film. The inert porous filler may be present in amounts of from approximately 0.005 to 50%, preferably 0.05 to 15%, more preferably approximately 0.5 to 10% by weight based on the total weight of the controlled permeability film. The inert porous filler may be dispersed throughout the polymeric film.

The plastic film in the bag may be biodegradable or compostable. An example of film technology for this use is disclosed in U.S. Pat. No. 6,984,426. In the process of buying the produce in a biodegradable bag, the consumer can then put any discarded produce back in the bag after use and throw the bag in an appropriate waste container.

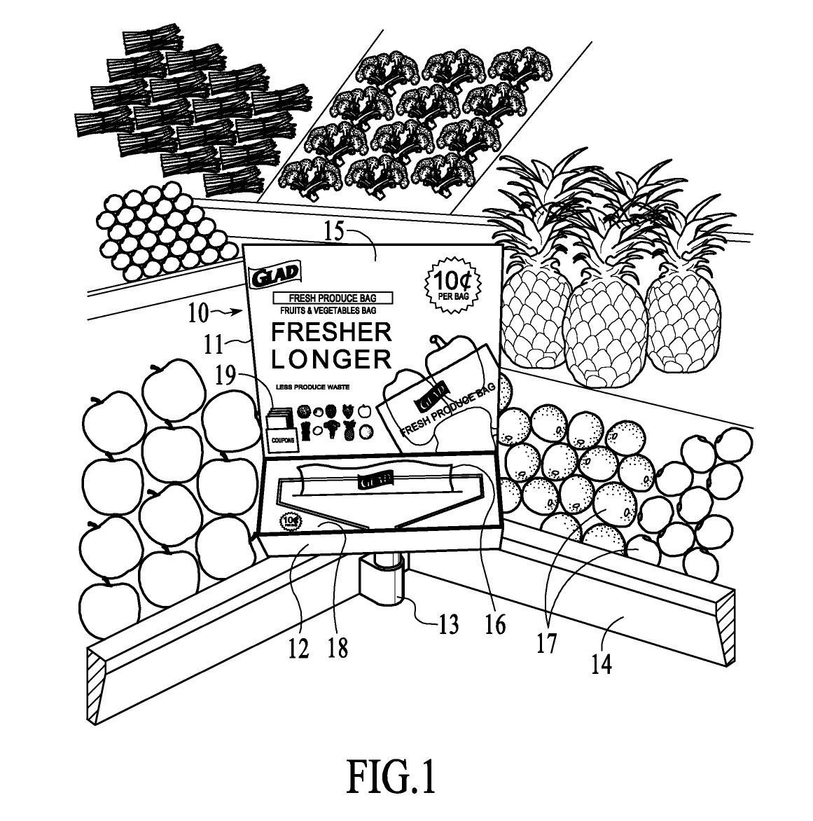

FIG. 1 illustrates a display unit 10 for single bag sales in accordance with an embodiment of the invention. As shown, the display unit 10 includes a corrugated header 11, a corrugated container 12 attached to the corrugated header 11, and a support structure 13 for supporting the corrugated header 11 and corrugated container 12. The support structure 13 may be a coupling member for affixation to a produce counter 14 counter containing fresh food items 17 sold in bulk. The corrugated header 11 provides a visual display 15 providing visual information about the use of the bags 16 and produce or fresh food items 17. The corrugated container 12 removably holds a corrugated packet 18 for wholly flexible, individual storage bags 16. The visual display 15 may include a product display showing the produce or other product for use with the bag, a representation of the bags or the bags in suitable secondary packaging such as a carton, and may include advertising information such as price or benefits, such as food freshness, or other items of visual interest. The visual display 15 may also contain coupons 19 or other advertising for the individual storage bags 16, or other products, such as produce or container products.

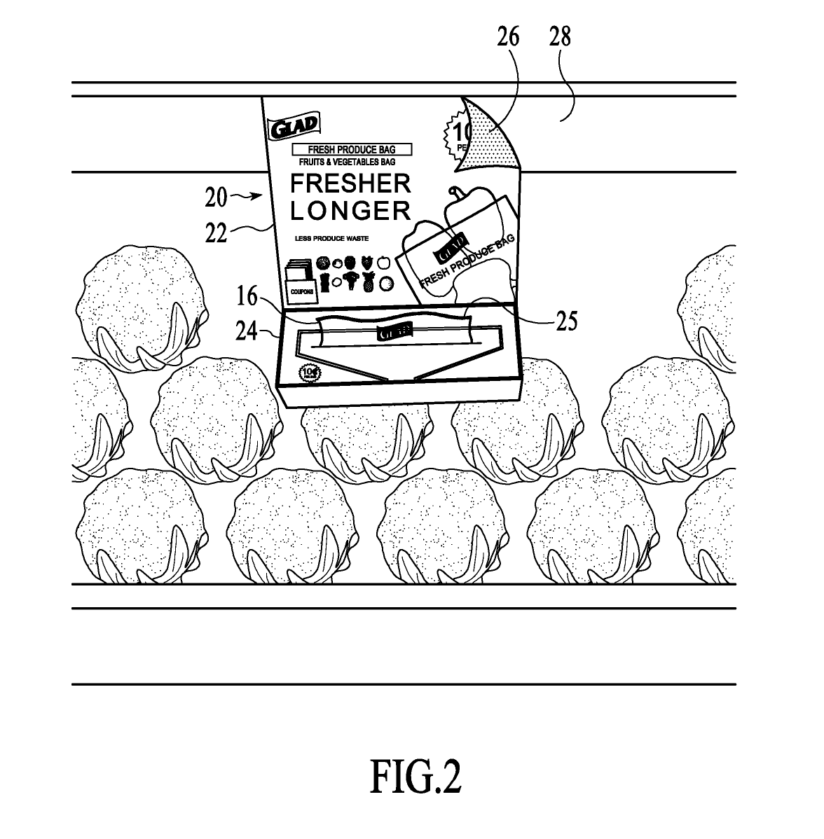

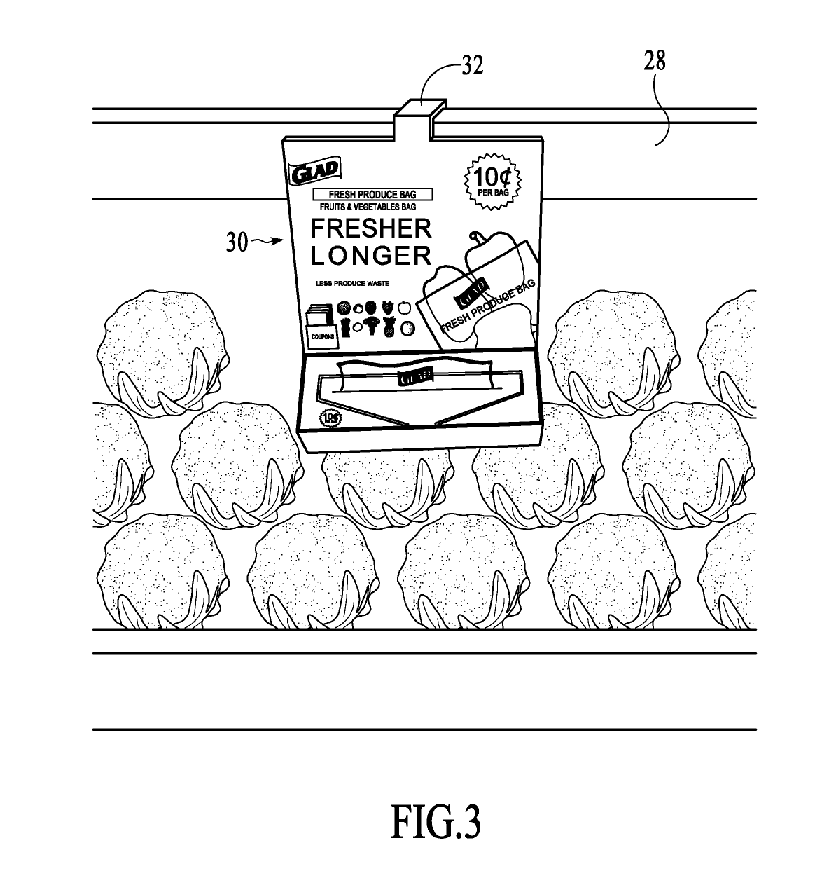

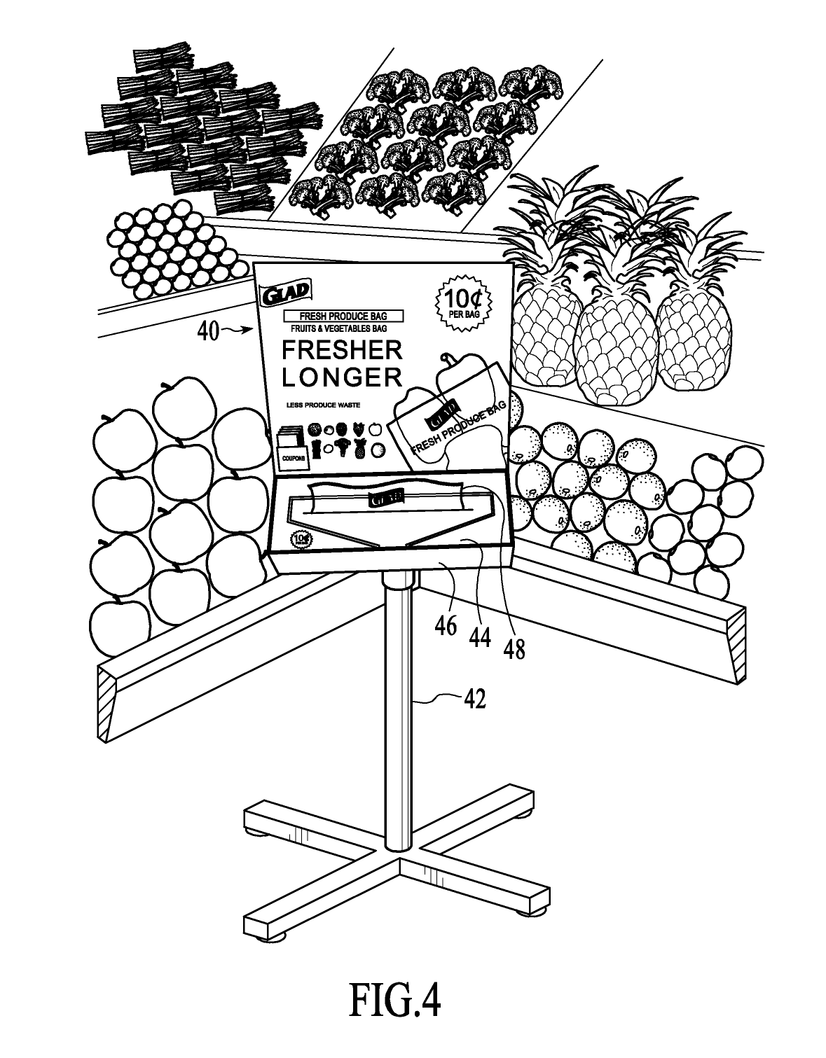

Alternatively, as in FIG. 2, the display unit 20 may have a plastic display header 22 attached to a plastic container 24 containing single purchase bags 16, where the display unit 20 has a coupling member 26 comprising may an adhesive member provided on a rear surface of the display unit 20 for attachment to a produce counter or other shelving unit 28. The bags 16 may have an integrated closure, for example a zipper 25. Another example of a suitable integrated closure is a slider. In FIG. 3, the display unit 30 may include a clip 32 for coupling to a shelf 28 of a store. Thus, the display unit 20 may easily be provided near the produce or other product being sold. In FIG. 4, a display unit 40 can have an independent support structure or free-standing floor stand 42 reaching to the floor. A packet 44 may removably fit in the corrugated container 46 of the display unit 40. The packet 44 may contain a plurality of removeably, wholly flexible storage bags 48. In FIG. 5, a roll 50 of single purchase food freshness bags 16 fits under the produce counter 52. The bags 16 may include a integrated closure, for example a zipper 54, or alternately a slider closure (not shown). The bags 16 are attached to one another on the roll 50 by a line of perforation 56.

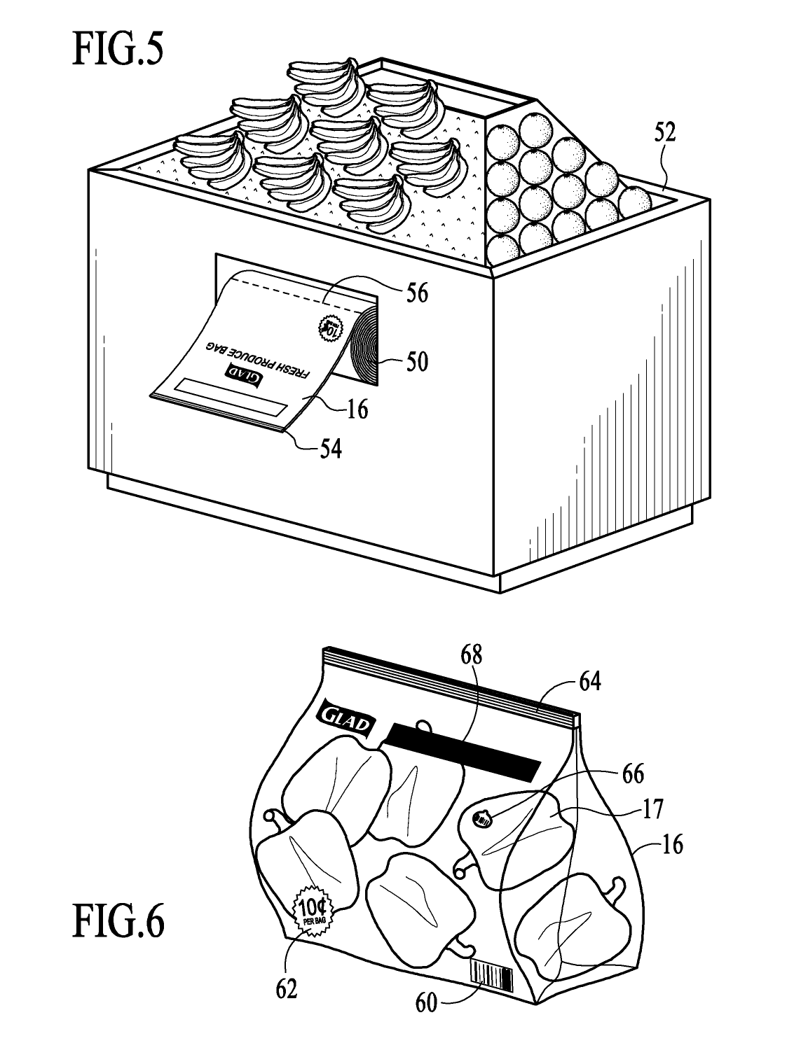

FIG. 6 shows a single transparent produce bag 16 of the invention filled with produce or fresh food items 17. The bag 16 has a universal product code 60 and a price label 62 including the product cost per bag. The bag 16 has an integral closure, a zipper closure 64. The bag additionally has a write on strip 68 for characterizing the produce or date. Inside the bag are individual items of produce 17 also having a universal product code 66. When the customer decides to purchase a single transparent produce bag 16 and fills it with the desired amount and quality of fresh food items 17 having a universal product code 66, the customer can proceed to checkout and purchase in one transaction the combination of the desired amount and quality of fresh food items 17 and the single transparent produce bag 16. The store clerk can merely scan both the fresh food item universal product code 66 and the bag universal product code 60. The customer or store clerk is not required to open the bag 16 or to remove the fresh food item 17 from the bag 16, before completing the transaction.

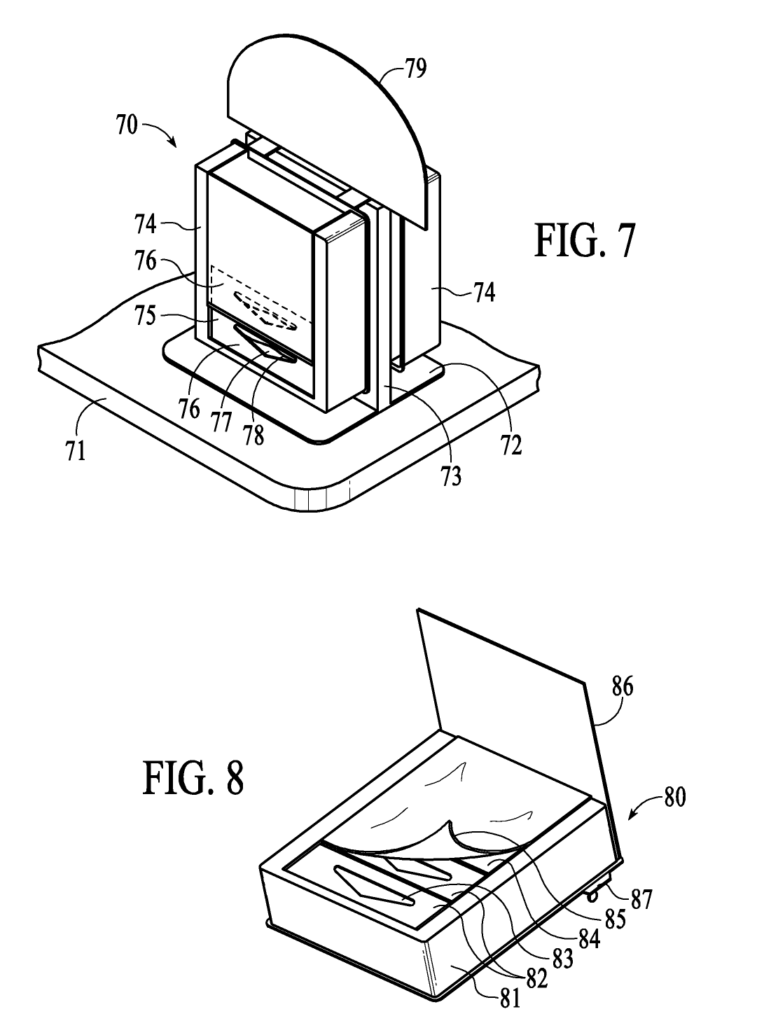

FIG. 7 shows a two-sided free-standing display unit 70 that can be placed on a flat counter 71. The display unit 70 has a base 72 and a riser 73. On each side of the riser 73 is removeably attached a corrugated container 74. The corrugated container 74 has an opening 75 for accessing and removing a packet 76. The corrugated container 74 contains a plurality of packets 76. Each of the packets 76 contains an opening 77 for removing a bag 78. The display unit 70 also has a removable corrugated header 79. FIG. 8 shows a display unit 80 having a corrugated container 81 holding a plurality of non-removable packets 82. The packets 82 have an opening 83 that may be accessed through an opening 84 in the container 81. The container opening 84 may be formed by removing the container cover 85. The container 81 may have a corrugated header 86 and an attachment mechanism 87.

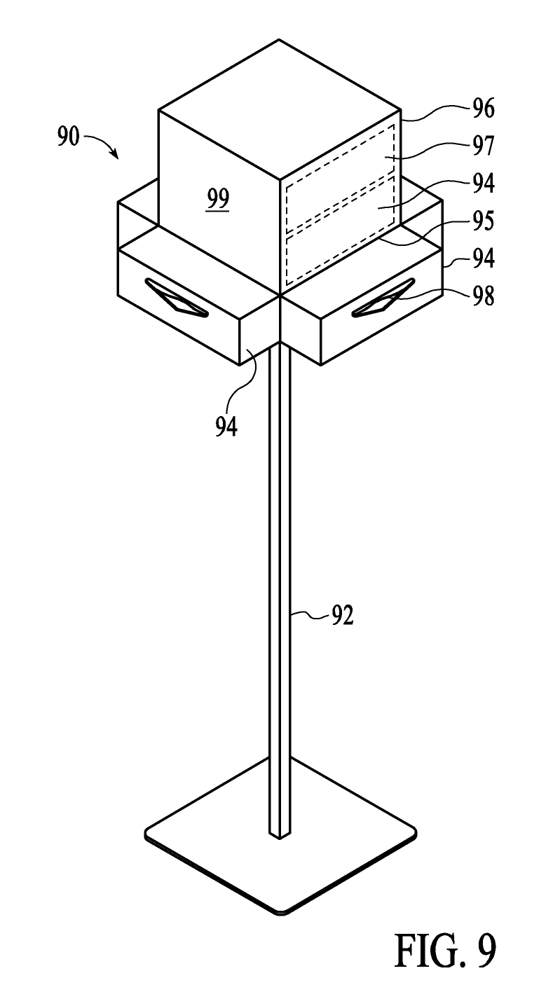

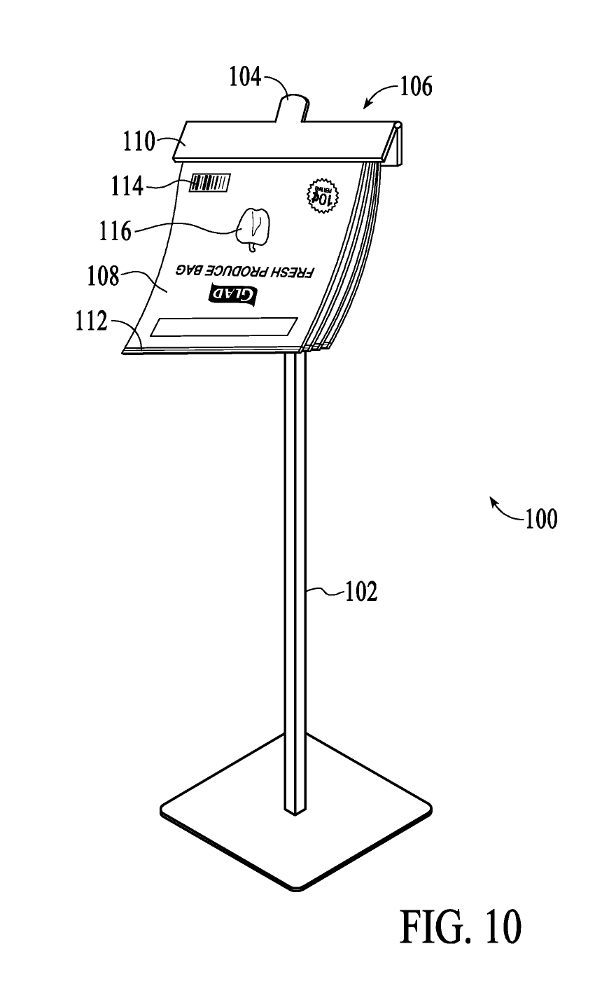

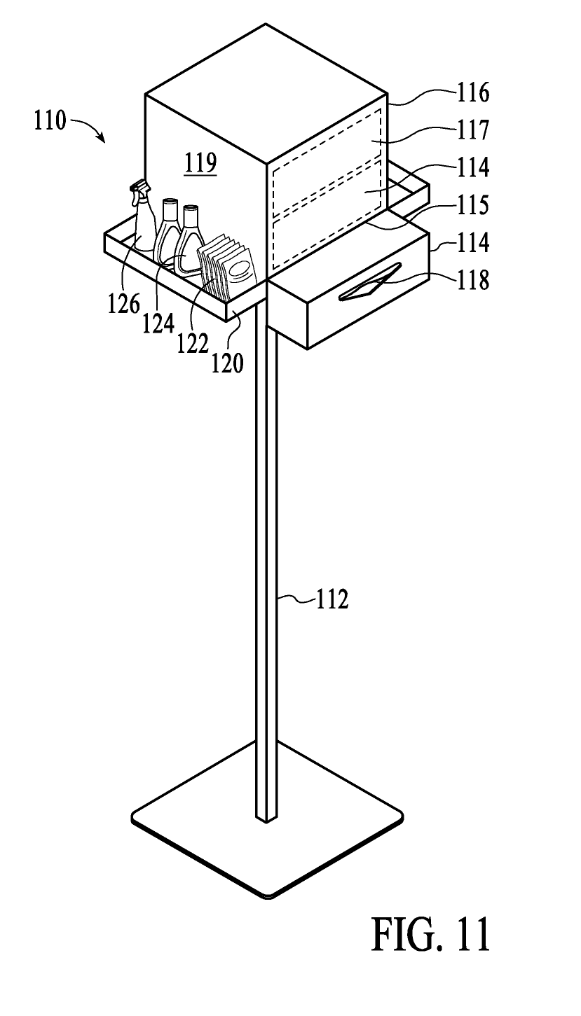

As shown in FIG. 9, a display unit 90 can have an independent support structure or free-standing floor stand 92 reaching to the floor. A packet 94 may removably fit in the corrugated container 96 of the display unit 90. The packet 94 may extend out from an opening 95 in the vertical wall 97 of the corrugated container 96 and may contain a plurality of removable, wholly flexible storage bags 98. The packet 94 may be removable and removing the packet 94 may allow an additional packet 94 to drop into place in the opening 95 of the corrugated container 96. There may be multiple packets 94 extending and available from the corrugated container 96 at one time. The vertical wall 97 of the corrugated container 96 has space 99 for a graphical representation of suitable fresh food items. As shown in FIG. 10, a display unit 100 can have an independent support structure of free-standing floor stand 102 reaching to the floor. On the stand may be an attachment post 104 to which is attached a clip display 106 containing a plurality of individual wholly flexible storage bags 108 attached together by a clip 110, where the clip 110 is attached to the attachment post 104. Each storage bag 108 may contain an integrated closure 112, a universal product code 114, and a depiction 116 of a fresh food item. As shown in FIG. 11, a display unit 110 can have an independent support structure or free-standing floor stand 112 reaching to the floor. A packet 114 may removably fit in the corrugated container 116 of the display unit 110. The packet 114 may extend out from an opening 115 in the vertical wall 117 of the corrugated container 116 and may contain a plurality of removable, wholly flexible storage bags 118. The packet 114 may be removable and removing the packet 114 may allow an additional packet 114 to drop into place in the opening 115 of the corrugated container 116. There may be multiple packets 114 extending and available from the corrugated container 116 at one time. The vertical wall 117 of the corrugated container 116 has space 119 for a graphical representation of suitable fresh food items. The container 116 may contain a receptacle 120 for displaying additional products that the consumer can use with the fresh food items. Examples of such additional product are envelopes 122 of seasonings or dry salad dressing mix, bottles 124 of related products such as salad dressing, and spray trigger containers 126 of treatment products, such as sanitizing spray or vegetable wash. The additional products may either be trial size products, or full size containers for sale.

Access to bags according to the invention can be simple (bags placed nearby a fresh food display) or the bags or other containers could be made available from a dispensing machine. If a machine is used, the store would have the opportunity to charge for the container at the time of dispensing. Additionally, the store could use space on a dispensing machine to describe the benefits of using the containers for storage, and permit the user to purchase containers individually by depositing a coin in the machine, or by using any electronic means, such as the swipe of a credit or debit card, using an input code provided by the store for the purchasers account, or by wireless signal sent to the machine, for example from a cell phone or other device carried by the consumer. In any case, it is most preferred that the containers be positioned adjacent to the fresh food that would be placed in the containers and/or in a position in which a customer would have a line-of-sight to the containers while shopping for the fresh food as a reminder of the availability and benefit of using the containers. In one embodiment, the bags may be prefilled with produce, so the consumer simply check out the produce already packaged in an appropriate freshness bag, while paying for a single freshness bag.

Containers that can be used in the method of the invention may be made of any material suitable for the carrying and storage of the fresh food with which they will be used. Plastic and paper will be the most common examples. The containers may take the form of a bag (structured or unstructured) or a harder plastic container, similar to those sold under the Tupperware® or Gladware® brands.

An important aspect of the invention is the opportunity for the store to sell, and for the consumer to buy, the container individually for immediate use in the store and pay for it separately from the food in the container. This can be accomplished many ways. In one form of the method of the invention, the store will charge the customer for the container on a “per container” basis at the time of checkout, along with the food. Another approach would be to permit the customer to purchase the container while shopping, for example in the produce section of the store, from a kiosk or machine. In either case, the method of the invention differs from the current method for purchasing fresh food in the thin plastic bags commonly given away by grocers. In this current and prior method the food and bag are weighed together at the time of checkout and the customer may pay some amount, although it may be very small, by weight of the bag along with the food. In the method according to the invention, however, the customer pays for the container not by weight, but on a price-per-container basis. The advantage is that the consumer can purchase only so many containers as are needed at a particular time, and at the same time, place the fresh food in the container in the store. There is then no need to replace the food in a different container when the food is taken home, simplifying storage and maximizing the chances that the fresh food will be stored properly to insure freshness. The food will then stay fresher longer and the consumer will benefit from avoiding spoilage before the food was to be consumed. The amount charged will reflect this benefit. For the grocer the advantage is the revenue stream generated by the consumer's purchase of the container.

What is claimed is:

1. A method for selling an individual storage bag, the method comprising the steps of:
(1) providing to a store customer a fresh food item sold in bulk, the fresh food item selected from the group consisting of fruit, vegetables, and combinations thereof;
(2) providing a display unit having a description of a suitable fresh food item and a plurality of packets, each packet having a plurality of empty, wholly flexible individual storage bags with integrated closures, wherein the customer can remove an individual storage bag from a packet without first paying for the individual storage bag or the packet;
(3) permitting the customer to place the desired amount of fresh food item inside the empty, individual storage bag to obtain a desired amount of fresh food item packaged in the storage bag for freshness, the individual storage bag including a characteristic that permits food stored in the individual storage bag to remain fresh longer than if the food item is not stored in the individual storage bag; and
(4) permitting the customer to purchase in one transaction the combination of the desired amount of fresh food item and the individual storage bag, the individual storage bag purchased on a per unit basis and the fresh food item purchase on a per weight basis, the transaction not requiring the removal of the fresh food item from the individual storage bag.

2. The method of claim 1 wherein the display unit comprises a corrugated header having a description of a suitable fresh food item.

3. The method of claim 1 wherein the corrugated header is removable from the display unit.

4. The method of claim 1 wherein each of the packets is removable from the display unit.

5. The method of claim 4 wherein the display unit has an opening and each of the packets have an opening, the display unit opening aligned with the opening of at least one of the packets, the individual storage bag being removable from a packet opening.

6. The method of claim 1 wherein the display unit additionally comprises a free-standing floor stand.

7. The method of claim 1 wherein the display unit is attached to a counter containing the fresh food items sold in bulk.

8. The method of claim 1 wherein the integrated closure is a zipper.

9. A method for selling an individual storage bag, the method comprising the steps of:
(1) providing to a store customer a fresh food item sold in bulk, the fresh food item selected from the group consisting of fruit, vegetables, and combinations thereof, the fresh food item having a first universal product code marking;
(2) providing a display unit having a plurality of packets, each packet having a plurality of empty, wholly flexible individual storage bags each having an integrated closure, wherein the customer can remove an individual storage bag from a packet without first paying for the individual storage bag, the individual storage bag being suitable for individual sale, the individual storage bag including a characteristic that permits food stored in the bag to remain fresh longer than if the food item is not stored in the bag, the individual storage bag having both a description of suitable fresh food items and a second universal product code marking;
(3) permitting the customer to place the desired amount of fresh food item inside the empty, individual storage bag to obtain a desired amount of fresh food item packaged in the storage bag for freshness and to close the integrated closure; and
(4) permitting the customer to purchase in one transaction the combination of the desired amount of fresh food item and the individual storage bag, the individual bag purchased on a per unit basis and the fresh food item purchase on a per weight basis, the transaction allowing reading of both the first universal product code marking and the second universal product code marking, the transaction not requiring opening of the integrated closure and the removal of the fresh food item from the individual storage bag.

10. The method of claim 9 wherein the display unit comprises a corrugated header having a description of a suitable fresh food item.

11. The method of claim 9 wherein each of the packets is removeable from the display unit and wherein the display unit has an opening and each of the packets have an opening, the display unit opening aligned with the opening of at least one of the packets, the individual storage bag being removeable from a packet opening.

12. The method of claim 9 wherein the display unit additionally comprises a free-standing floor stand.

13. A method for selling a wholly flexible individual storage bag, the method comprising the steps of:
(1) providing to a store customer a food item sold in bulk, the food item selected from the group consisting of fruit, vegetables, and combinations thereof;
(2) providing a display unit having a header, a container, and a free-standing floor stand, the container having a plurality of packets, each packet having a plurality of empty, wholly flexible individual storage bags each having an integrated closure, wherein the customer can remove an individual storage bag from a packet without first paying for the individual storage bag, the individual wholly flexible storage bag including a characteristic that permits food items stored in the bag to remain fresh longer than if the food item is not stored in the storage bag, the individual wholly flexible storage bag having both a description of a suitable food item and a universal product code marking;
(3) permitting the customer to place the desired amount of food item inside the empty, wholly flexible individual storage bag to obtain a desired amount of food item packaged for freshness, the individual storage bag including a characteristic that permits food stored in the individual storage bag to remain fresh longer than if the food item is not stored in the individual storage bag; and
(4) permitting the customer to purchase in one transaction the combination of the desired amount of food item and the wholly flexible individual storage bag, the wholly flexible individual storage bag purchased on a per unit basis and the food item purchase on a per weight basis, the transaction not requiring the removal of the food item from the wholly flexible individual storage bag.

14. The method according to claim 13, wherein each of the packets is removable from the display unit and wherein the display unit has an opening and each of the packets have an opening, the display unit opening aligned with the opening of at least one of the packets, the individual storage bag being removable from a packet opening.

15. The method of claim 13 wherein the header is removable from the display unit.

16. The method of claim 13 wherein the corrugated header has a description of a suitable fresh food item.

17. The method of claim 13 wherein the integrated closure is a zipper.
